(19) United States
(12) Patent Application Publication
(10) Pub. No.: US 2004/0215738 A1
(43) Pub. Date: Oct. 28, 2004

(54) Modulated network integrating system

(75) Inventor: Ding-Kung Shieh, Taipei (TW)

Correspondence Address: BACON & THOMAS, PLLC, 625 SLATERS LANE, FOURTH FLOOR, ALEXANDRIA, VA, 22314

(73) Assignee: EVER-UP TECHNOLOGY CO., LTD., Taipei (TW)

(21) Appl. No.: 10/397,205

(22) Filed: Mar. 27, 2003

(51) Int. Cl. G06F 15/16

(52) U.S. Cl. 709/217

(57) ABSTRACT

The present invention relates to a modulated network integrating system especially one applying to different special global network connection demands. The present invention mainly modulates a sensor, a data processing control unit, a communicating system and platform, world-wide web, data base, an information management applying system unit, and a page and interface control unit to provide the user with a fast combined system in developing system. Hence, this invention is a very efficient and economical communication package.

### TECHNICAL RANGE

The present invention relates to a modulated network integrating system especially one applying to different special global network connection demands

### INVENTION BACKGROUND

Usually, when large systems such as information medical treatment system, command information system, 3C related integration, and ID security identifying and billing system are being developed, the most common technology is used. A non-modulated closed system technology is designed for only one specific function that cannot comply with the needs of advancing technology in a fast-progressing scientific world according to different environment. It is therefore quite impossible to develop a low-capital, efficient and expanding system to satisfy customers' demands as a large system includes a sensor, hardware, software, information, communication, data base, electric, and control.

In order to improve the lack of technology mentioned-above, the present invention modulates a sensor, data processing control unit, communication system and platform, world-wide web, data base, unit applying information system, page and interface control unit to provide the user with a fast combined system in developing system.

### SUMMARY OF INVENTION

The present invention relates to a modulated network integrating system different in conception and functioning. First of all, the data processing control unit passes through the communicating interface USB, RS232 and so on and receives information from different sensors in a specific range such as video, audio, data, words and so on. The information is then stored, calculated and controlled and passes through the communication transition module mainly network interface GSM, GPRS, CDMA, 802.11a/b, RF and so on. The related information is then transmitted to internet through cable or wireless cable to different data centers of computer system and connected to different databases. The information management applying system unit catches information needed by the database, unitize all programs required and can directly be transmitted to internet. With the use of interface, control unit is transited and connected to different information systems such as audio and geography information of supplying firms. In relation to the concepts of developed systems mentioned-above, the user can choose suitable hardware platform and database without any limitations and little adjustments in designing software will be required when the motherboard or database are being changed. This system can not only match with different systems but it can also help users to module required systems thus increasing operation efficiency and quality of service.

### Efficiency of Invention

The present invention relates to a modulated network integrating system as characterized below:

1. Modulate: software as well as hardware designed and for different sensors, communication platform and operating model and lightly adjusted to maintain elasticity and reduce time.

2. Network: to reach opening of system.

3. Integrating technology: use of technology joined with subsidiary system to provide an easy integration.

4. Elasticity: quick arrangement and choice of user.

5. System design: opening structure.

### DESCRIPTION OF DRAWING

FIG. 1 shows a plan of the modulated system

### NUMERICALS

10—sensor 11—data processing control unit

101—encode 12—communicating module

13—communication system and platform

14—interface 102—decode

15—internet data center data base

16—interface

17—information management applying system unit

103—encode 104—WWW server

105—decode 18—control interface

19—other

### Mode for Carrying Out Invention

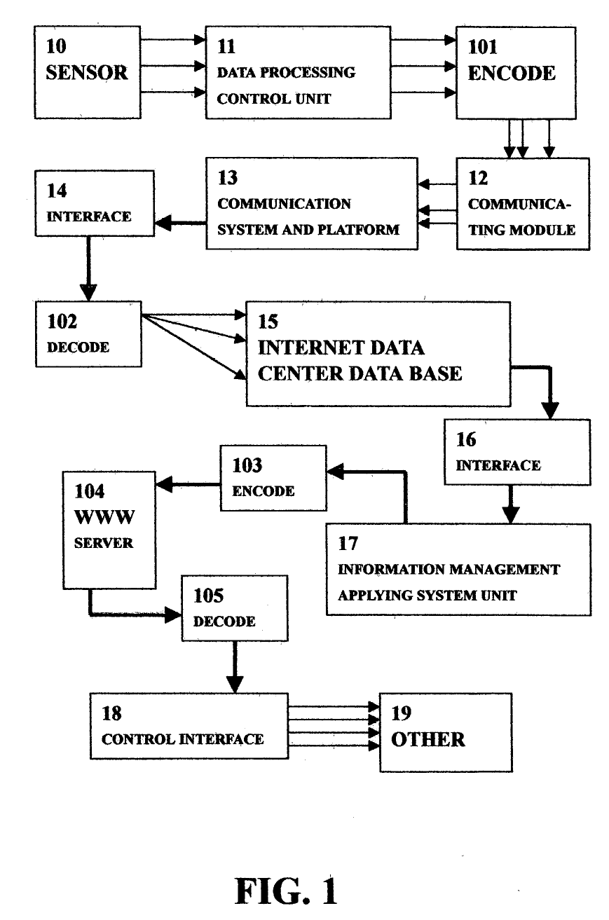

With reference to FIG. 1 showing a plan of the modulated system, sensor 10, data processing control unit 11, encode 101, communicating module 12, communication system and platform 13, interface 14, decode 102, internet data center data base 15, interface 16, information management applying system unit 17, encode 103, WWW server unit 104, decode 105, control interface 18 and other 19 are modulated to obtain a network integration system.

With further reference to FIG. 1, when data processing control unit 11 receives information of different sensors 10 (such as video, audio, data, words from manufacturing firms) through USB, RS232, information is stored, calculated and controlled and send through communicating module 12 after encoding 101. Communicating modules 12 consist of interfaces GSM, CDMA, 802.11a/b, RF and so on and through the intermediary of communication system and platform 13 pass through interface 14 for transition and decoding process (102). The information is then transmitted to internet by cable or wireless cable to different data centers of computer system and connected to different databases (internet data center database 15). Further, the information management applying system unit 17 catches information required by the database (15) through transition of interface 16 and can directly go to internet after integration of required programs passing through encode 103 to WWW server 104 and decode 105. The information is then transited through control interface and connected to supplying firms information systems such as audio and geography information (others 19). Hence, according to the concepts of developing systems mentioned-above, the use can choose suitable hardware platform and database without any limitations and little adjustment in designing software is required when the motherboard or database is being changed. This system can not only match with different systems but it can also help users to module required systems thus increasing operation efficiency and quality of service.

According to the present invention of a modulated network integrating system mentioned-above, information medical treatment system can be rapidly integrated as follows:

1. The use of medical equipment measurements such as pulse, blood pressure, acupuncture, breath machines and so on to detect patients' situation.

2. Measurement of data with the intermediary of interface RS232 transmitted to data control unit comprising a microprocessor to control the operation of received devices, data receiving module (sensor) and connected to said microprocessor circuit for transmission of data and storing after calculation such as CF card. The result timely transited with compliance with the transmission control/internet transmission agreement package through network control circuit packaging and transmitted to http server or e-mail server by cable or wireless modules 802.11a/b, GPRS, CDMA, RF and so on.

3. Information such as audio, video, data, words and so on received by the computer control center from http server are stored in database or suitable files through an interface unit;

4. The patients' medical treatment system can inform patients of present situations from above-mentioned database and can provide medical treatments and judgements on the web-site for further inquiries;

5. By means of safety mechanism, doctors can be informed of their patients' conditions in any places and can then provide suitable medical judgements.

Apart from the case mentioned-above, the present invention can also be applied to command information system, ID security identifying system, motion billing system, household appliances, monitors, toys and 3C related integration.

1. A modulated network integrating system mainly comprising a sensor, data process control unit, encode, communicating module, communicating system and platform, interface, decode, internet data center database, interface, information management applying system unit, encode, WWW server, decode, controlling interface and others, wherein:
The data processing control unit receives information of different sensors (such as video, audio, data, words from manufacturing firms) through USB, RS232, information is stored, calculated and controlled and send through communicating module after encoding; Communicating modules consist of interfaces GSM, CDMA, 802.11a/b, RF and so on and through the intermediary of communication system and platform pass through interface for transition and decoding process; The information is then transmitted to internet by cable or wireless cable to different data centers of computer system and connected to different databases (internet data center database); Further, the information management applying system unit catches information required by the database through transition of interface and can directly go to internet after integration of required programs passing through encode to WWW server and decode; The information is then transited through control interface and connected to supplying firms information systems such as audio and geography information (others).

2. As mentioned in claim 1 of a modulated network integrating system, the user can choose suitable hardware platform and database without any limitations and little adjustment in designing software will be required when the motherboard or database is being changed; This system can not only match with different systems but it can also help users to module required systems thus increasing operation efficiency and quality of service.
